(19) United States
(12) Patent Application Publication
(10) Pub. No.: US 2004/0154250 A1
(43) Pub. Date: Aug. 12, 2004

(54) Self securing panel for work platform

(76) Inventor: Anastasios George Hatsios, Buffalo, NY (US)

Correspondence Address: Anastasios Hatsios, 65 Hirschbeck Street, Buffalo, NY, 14212, US

(21) Appl. No.: 10/359,073

(22) Filed: Feb. 6, 2003

(51) Int. Cl. E06B 3/28

(52) U.S. Cl. 52/506.01; 52/782.1

(57) ABSTRACT

A self securing work platform panel for temporary installation under or upon a structure and comprised of corrugated metal sheets which are secured to a support system such as, but not limited to, cables by means of a system of opposing hooks affixed to the underside of said metal sheets.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to work platform installation systems which are installed under or upon structures such as bridges to allow workers and equipment to repair and renovate said structure and more particularly to an improved work platform panel to allow for faster, easier and safer installation and operation; and better debris containment. Current panels are secured to cables through holes cut into the sheet and then a clip consisting of multiple parts is used to secure the sheet to the cable. Though care is taken to keep the hole covered, debris inevitably escapes the enclosed work area through these holes. Also with the fastening clip consisting of multiple parts, it is time consuming to fasten the sheets to the cables and there is also the opportunity for pieces to be dropped during installation allowing metal to fall to the ground, highway or water below creating a danger to motorists or persons below. And as parts get dropped and lost the installer will grab a part readily available such as a bolt or nut to complete the installation and the replacement part occasionally does not meet the specifications for which it is being used even though it may look like the same part to the installer.

### BRIEF SUMMARY OF THE INVENTION

It is the object of this invention to provide a work platform panel system with self securing platform panels which contain minimal parts to allow for faster and easier installation and lessen the opportunity for losing small parts such as nuts and bolts.

It is another object of this invention to provide a work platform panel which better prevents dust and debris from escaping outside the containment area.

In summary the work platform panel of this invention consists of a corrugated metal sheet with two sets of hooks affixed to the underside of the corrugated sheet towards one end, with at least one hook in each set. The hooks are affixed so that their lengths run parallel with the lines of corrugation and so that one portion of the hook is attached to the sheet in the valley of the corrugation and the other remaining portion of that hook hangs protruding below the plane of the metal sheet underside. The two sets of hooks are affixed to face in the opposite direction to one another. Thus when the panel is placed upon a support cable at an angle to the length of cable with each set of hooks on opposite sides of the support cable with open end facing the cable, as the panel is rotated upon the cable so that the hooks move towards the cable, the cable slides into the open ends of the hooks thereby securing the panel to the support cable. Another panel may then be placed upon a different support cable in the same manner and in such a way as to overlap the first panel. Then the second panel is fastened to the first panel at the overlap. Thus each panel will be secured to the support cables at both ends, at one end by the hooks fastened to it's underside and at the other end by the hooks of the previous panel which it overlaps and is attached to. By continuing to lay down successive panels in this manner a work platform floor may be created to a desired width and length. The first row of panels placed upon the support cables will not have a previous row of panels to be affixed to and will thus require a different means of securing the panels to the support cable at the end without the hooks. Any one of the means currently used by persons practiced in this field can be utilized such as U-bolts, wood and screws, or one of the many others. Also there can be multiple sets of hooks to fasten the panel to more than one cable at a time. This would necessitate the panel laying flat upon all the cables it is to be secured to with each set of hooks in the same relationship as previously described to the particular cable it will fasten to, and as the panel is turned upon the cables, all of the hooks lock in simultaneously.

### BRIEF DESCRIPTION OF THE SEVERAL VIEWS OF THE DRAWING

FIG. 1. Is a view of a single hook assembly showing the tube 13, the hooked rod 12 inserted through the tube 13 and the pin 14 inserted through the protruding straight end of the rod 12.

FIG. 2. Is a fragmentary view of a single hook assembly in the open position as would be while the panel was in use. Also Illustrating the movement of the hooked rod 12.

FIG. 3. Is a fragmentary view of a single hook assembly in the closed position as would be while the panel was in storage or transport. Also illustrating the movement of the hooked rod 12

FIG. 4. Is a fragmentary underside view of a single corrugated metal panel 11 showing two hook assemblies attached to the panel 11 as they secure the panel 11 to a support cable 15.

FIG. 5. Is an underside view of a single corrugated panel 11 secured to a support cable 15b by two hook assemblies and resting on top of support cables 15c and 15d.

FIG. 6. Is two platform panels secured together as they would be upon support cables as viewed from the side.

FIG. 7. Is an underside view of a single corrugated metal panel 11 as seen in FIG. 5 secured to a support cable 15b by two hook assemblies illustrating the movement of rotating the panel 11 upon the support cable 11b so as to slide the cable 15b into the hooks 12a and 12b thereby securing the panel 11 to the cable 15b.

### DETAILED DESCRIPTION OF THE INVENTION

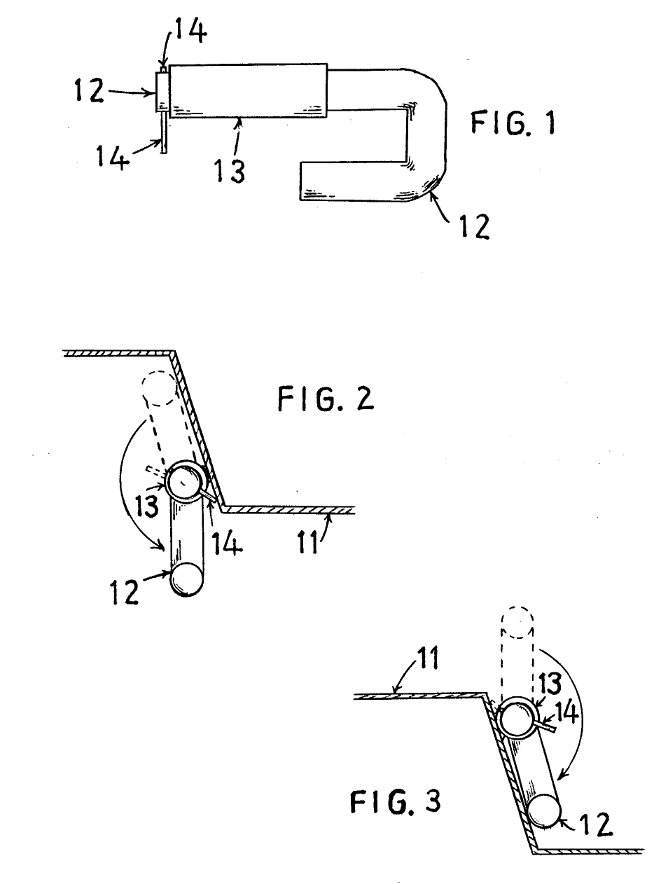

Referring to FIG. 1 there is shown a single hook assembly which is comprised of a metal tube 13 and a metal rod 12 which has been bent in a hooked or J shape. The hooked rod 12 is inserted into the metal tube 13 so that it protrudes slightly out the other end of the metal tube 13 where a pin 14 is inserted into the end of the hooked rod 12 to prevent the hooked rod 12 from being pulled back out of the metal tube 13. The size and, dimensions of the metal tube 13 and the hooked rod 12 are dependant on the capacity specifications of the specific application that they are being used for. A person skilled in the art of platform and scaffold fabrication and installation can determine the gauge and size of the hooked rod 12 and metal tube 13 needed for the specific application requirements. The size relationship of the metal tube 13 to the hooked rod 12 should be such that the hooked rod 12 can be easily inserted and rotate freely inside the metal tube 13 but have limited lateral movement. Generally a metal rod 12 of ⅜-inch diameter and 4-inch length prior to bending will be sufficient. The diameter of the bend in the hooked rod 12 will be dependant on the diameter of the support cable 15 it is being secured to. The hooked rod 12 should allow for the support cable 15 to fit snugly into the hook.

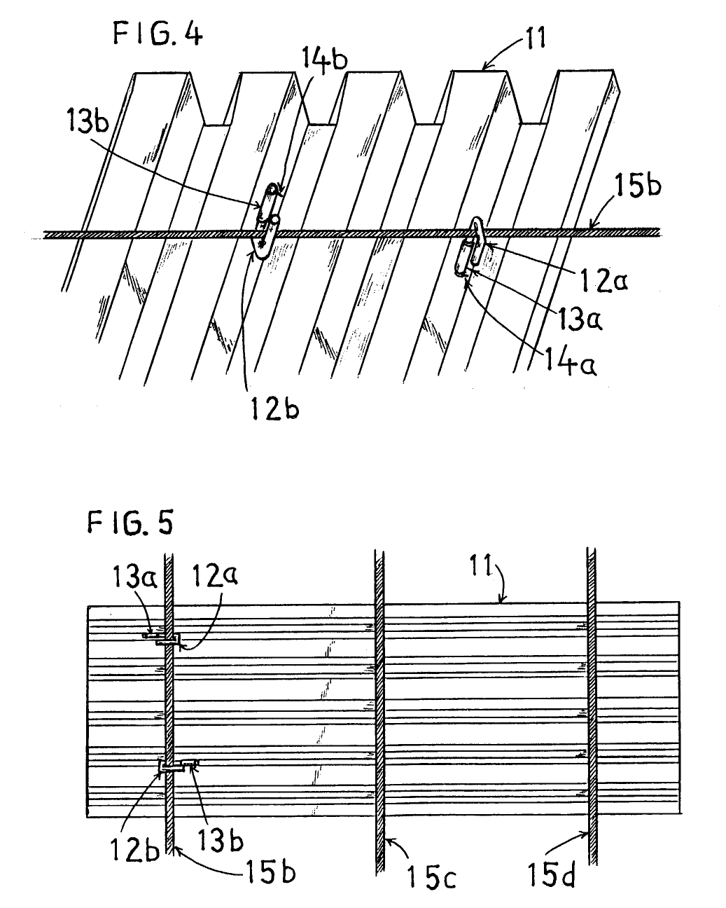

Referring to FIG. 1, FIG. 2, and FIG. 3; the pin 14 should be of such size so as to be flush with the surface of the hooked rod 12 and so as to not extend beyond the outside surface of the metal tube 13 on one end after being inserted into the hooked rod 12 and protrude far enough out of the other end of the hooked rod 12 so as to be able to strike the side of the corrugated metal sheet 11 to keep the hooked rod 12 from rotating past the 90-degree perpendicular position in relation to the overall plane of the corrugated metal sheet 11 when the metal sheet 11 is flipped with hooks side down as in FIG. 2 which is the position the sheet 11 and hooked rod 12 would be in when being secured as in FIG. 4 to a support system such as a cable 15b. The flush or nearly flush end of the pin 14 is to allow the hooked rod 12 to rotate freely without the flush end of the pin 14 striking the corrugated metal sheet 11 or otherwise interfering with the rotating movement of the hooked rod 12. The size and position of the pin 14 as inserted into the metal rod 12 will be dependant on the gauge of the hooked rod 12 and the type of corrugation of the metal sheet 11. A person skilled in the art of platform and scaffold fabrication and installation will be able to determine the pin 14 size and angle of insertion into the hooked rod 12 by first determining the gauge of the metal rod 12 and the type of corrugation of the metal sheet 11.

Referring to FIG. 2 and FIG. 3 the hook assembly of FIG. 1 is attached to the metal corrugated sheet 11 along the mostly vertical portion of the corrugation as close to the open end of the corrugation where it turns horizontal and so that the metal tube 13 does not protrude above or below the horizontal surface of the metal sheet 11′. This is necessary to allow the metal sheets 11 to be stacked for storage or transport with limited interference from the hook assembly. The metal tube 13 is the only portion of the hook assembly to be secured to the metal corrugated sheet 11, this allows for the metal hooked rod 12 to rotate freely so that when the metal sheet 11 is flipped with the hook assembly on top as in FIG. 3 the metal hooked rod 12 will fall into the valley of the corrugation so as to have limited interference with successive metal corrugated sheets 11 being stacked upon it. It should be noted that this present invention uses rotating hooks to facilitate storage and transportation of the corrugated sheets, however there are other means available to achieve this, such as making the hooked rod or entire hook assembly removable for transportation and storage. The embodiment of the present invention is the use of opposing hooks to secure the corrugated metal sheet to a support system such as support cables.

Referring to FIG. 4 and FIG. 5 the hook assemblies are secured to the corrugated metal sheet 11 closer to one end of the corrugated metal sheet 11, so that the support cable 15b when secured by the hooked rods 12a and 12b, the support cable 15b runs 6-inches from that end of the metal sheet 11. The hook assemblies are secured so that the hooked, rods 12a and 12b face in opposing directions to one another. The exact distance between the two hook assemblies will be dependant on the corrugation however the distance should be approximately ⅓ the width of the corrugated metal sheet 11. Referring to FIG. 7 when installing the corrugated metal sheet 11 upon the support cables 15b, 15c and 15d. The corrugated metal sheet 11 is placed at such an angle to the support cable 11b which the hooked rods 12a and 12b will secured to so the open end of each hooked rod 12a and 12b is facing the support cable 15b as the corrugated metal sheet 11 is sitting, upon the support cable 15b. The corrugated metal sheet 11 is then rotated upon the support cable 15b so that the hooked rods 12a and 12b move towards the support cable 15b and the support cable 15b slides into the hooked rods 12a and 12b thereby securing the corrugated metal sheet 11 to the, support cable 15b. The corrugated metal sheet 11 is then laid flat upon the other remaining support cables 15c and 15d.

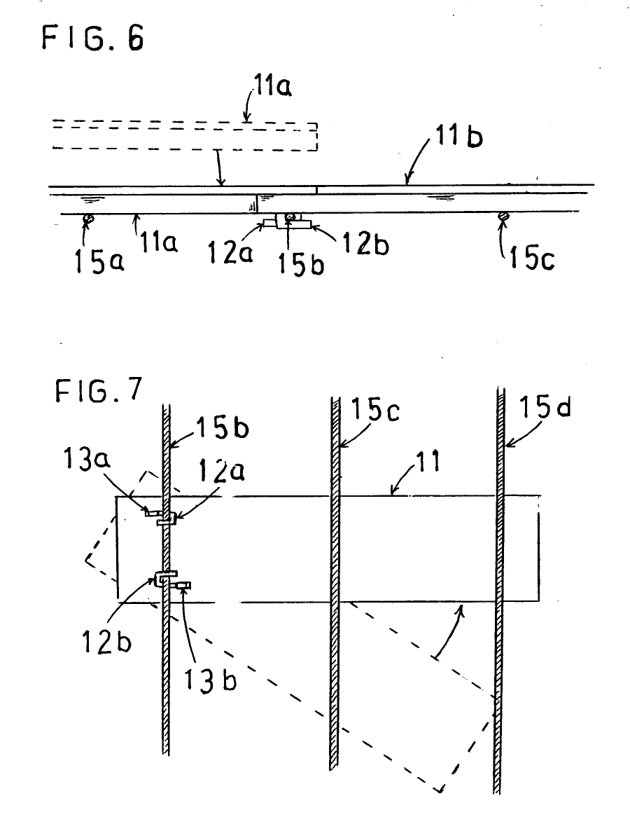

Successive corrugated metal sheets can be secured in an overlapping manner so as to form a work platform of desired length and width. Referring to FIG. 6, as the corrugated metal sheet 11a is laid flat upon the remaining support cables 15a and 15b it overlaps the previously secured corrugated metal sheet 11b by approximately 12-inches and then the corrugated metal sheet 11a is secured to the corrugated metal sheet 11b by temporary removable means such as metal screws or bolts. In this manner each corrugated metal sheet 11a and 11b will be secured at both ends to the system of support cables 15, at one end by the hooked rods 12, and at the other end by the hooked rods 12 of the previous corrugated metal sheet 11. When constructing a work platform the first row of corrugated metal sheets 11 will require a different means of securing the end which lacks hooked rods 12 to the support cable 15 since there will not be a previous row of corrugated metal sheets 11 to overlap and secure to. Referring to FIG. 7, if this corrugated metal sheet 11 were in the first row of sheets to be laid down to create a work platform then a different means of securing the corrugated metal sheet 11 to the support cable 15d would be needed. A person skilled in the art of platform fabrication and installation would be able to use a number of means currently available and in use for securing panels to support cables, such as but not limited to, U-bolts or wood and screws. The opposing hooks system used in the current invention facilitates the speed and ease to which successive corrugated sheets can be laid out and secured upon support cables to create a work platform for men and equipment and limits the number of openings required in the work platform since the opposing hooks system does not require holes in the corrugated metal sheets where the hooks secure to the support cables.

What is claimed is:

1. A work platform panel floor for temporary installation upon or below a structure such as a bridge to support men and equipment repairing or renovating said structure and to contain and collect debris resulting from the work, said work platform panel floor comprising;
a plurality of flooring panels laid down end to end and side to side in a slightly overlapping manner upon a support system such as cables and resting upon said cables and a means whereby the flooring panels are secured with minimal additional hardware to the main cables and interlock into the adjacent panels creating a work surface for men and equipment with minimal openings in the platform to better contain dust and debris.
